(19) United States
(12) Patent Application Publication
(10) Pub. No.: US 2018/0139806 A1
(43) Pub. Date: May 17, 2018

(54) METHOD AND APPARATUS FOR HEATING FLUIDS

(71) Applicant: William Whitney Burch, Livingston, TX (US)

(72) Inventor: William Whitney Burch, Livingston, TX (US)

(21) Appl. No.: 15/814,933

(22) Filed: Nov. 16, 2017

Related U.S. Application Data
(60) Provisional application No. 62/423,122, filed on Nov. 16, 2016.

(51) Int. Cl. H05B 6/80; H05B 6/60; C01B 32/15

(52) U.S. Cl. CPC H05B 6/802; C01B 2202/24; C01B 32/15; H05B 6/60

(57) ABSTRACT

A fluid stream is heated by providing heat generated by radiation absorbing carbon nanotubes.

### RELATED PRIORITY DATE APPLICATION

This application claims the benefit under 35 U.S.C. 119(e) of the U.S. provisional application No. 62/423,122 filed on Nov. 16, 2016.

### TECHNICAL FIELD OF THE INVENTION

The present invention relates to the field of heating fluids and, more particularly, to a method and apparatus for heating fluids in various industrial applications. Still more particularly, the present invention discloses a method and apparatus wherein microwave absorbing carbon nanotubes are used as heating elements to heat fluids in the presence of microwave radiation.

### BACKGROUND OF THE INVENTION

The heating of fluids in many industrial applications is well known and widespread. In most cases, steam, heat exchange with hotter streams and direct heat provided by fuel are used to elevate the temperature of a fluid stream to wholly or partially vaporize it, or to change its state or composition to effect various results.

One of the disadvantages of the present methods is that heat sources are not readily available in many place. Another disadvantage is that they require extensive equipment thereby increasing the cost of the operation. Still another disadvantage is that the existing heat sources are subject to accidents or other mishaps, thereby jeopardizing safety.

According to the present invention, a method and apparatus are used to heat an industrial fluid by utilizing microwave absorbing carbon nanotubes as heating elements. The use of such method and apparatus enhances safety and allows for the implementation of industrial application where other heat sources are not available or economical.

These and other advantages of the present invention will become apparent from the following description.

### SUMMARY OF THE INVENTION

A method and an apparatus for heating industrial fluids with carbon nanotubes in the presence of microwave radiation is disclosed. The apparatus includes a tubular element having an inner tube and a concentric outer tube forming an annulus therebetween which is packed with carbon nanotubes.

A microwave source emits microwave radiation that penetrates the wall of the outer tube and which is absorbed by the carbon nanotubes to generate heat. A liquid stream flows through the inner tube and is heated by heat generated by the carbon nanotubes. A plurality of tubular elements are installed in parallel in a clamber that contains the microwave radiation to provide for the flow of large amount of fluid therethrough.

Temperature probes are installed on the inlet and outlet of the tubular elements to monitor the temperature rise of the stream flowing therethrough and the fluid temperature is controlled by managing the flow rate of the fluid for the required outlet temperature, power supplied to the microwave source and the frequency and duration of the microwave pulses. Preferably, solar panels are provided to supply the required power.

The apparatus and method may be used to raise temperature of fluids under a wide range of pressures in various applications including distillation operations in the refining and petrochemical industry, the production of alcohol products, or the treatment of water such as seawater, brines, brackish, wastewater, contaminated fresh water supply sources or water produced in conjunction with oil and gas operations. Further, the method or apparatus may be also used for basic tasks such as the heating of a cold fluid to a required use or reaction temperature such as cold hydraulic fracturing liquids, input feeds to refining distillation columns, or heating of water for residential use.

### BRIEF DESCRIPTION OF THE DRAWING

For a more detailed description of the preferred embodiment of the invention, reference will now be made to the accompanying drawings, wherein:

FIG. 1 is a three dimensional schematic of a portion of the present invention;

FIG. 2 is a cross section of the apparatus of FIG. 1; and

FIG. 3 is a three dimensional schematic of a plurality of tubes of FIG. 1 enclosed in a chamber.

### DETAILED DESCRIPTION OF THE INVENTION

According to the present invention, a method and an apparatus for heating industrial fluids with carbon nanotubes in the presence of microwave radiation is disclosed.

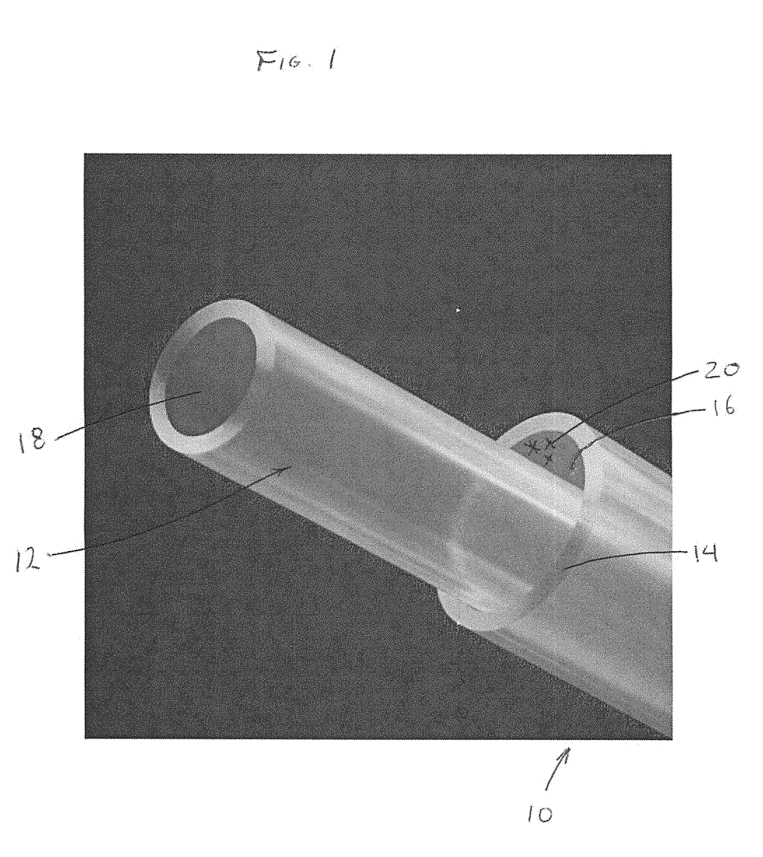

Referring now to FIG. 1, there is shown a three dimensional schematic of a portion of a tubular element 10 of the apparatus of the present invention having an inner tube 12 and a concentric outer tube 14 forming an annulus 16 therebetween. Inner tube 12 has a flow passage 18 therethrough for flowing a fluid to be treated in accordance with the present invention. The wall of inner tube 12 is made of heat conductive material.

The wall of outer tube 14 is constructed of material that can be penetrated by microwave radiation such as glass. Annulus 16 is packed with microwave absorbing carbon nanotubes 20 which can be irradiated by an external microwave source (not shown) to become a heat source for fluid flowing through flow passage 18.

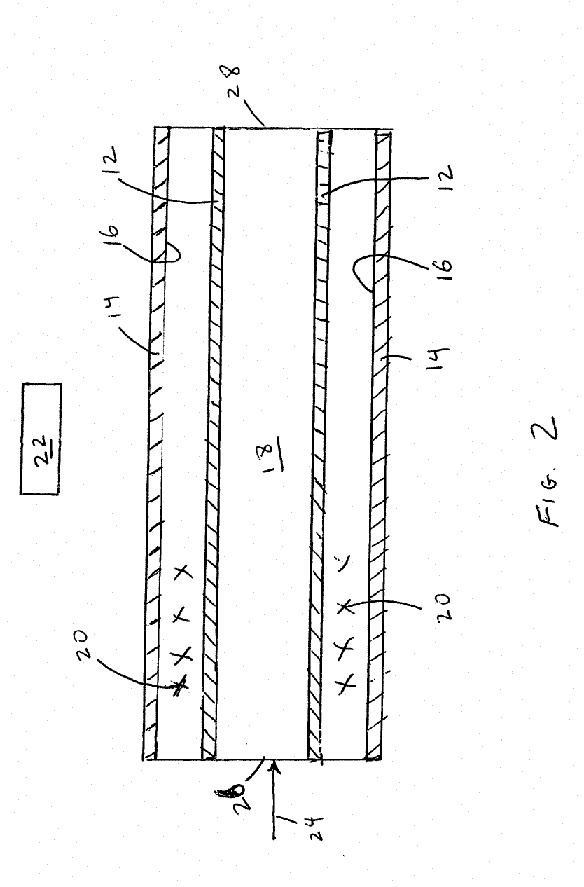

Referring now to FIG. 2, there is shown a cross section of inner tube 12 being concentrically disposed in outer tube 14 forming annulus 16 therebetween. Annulus 16 is packed with carbon nanotubes 20. A microwave source 22 emits microwave radiation which can penetrate the wall of outer tube 14 and can be absorbed by carbon nanotubes 20 to generate heat. A well known apparatus known as magnetron may be used as microwave source 22. A liquid stream 24 flows to flow passage 18 via inlet 26 and exits therefrom via outlet 28. Heat generated by carbon nanotubes 20 is transferred to stream 24 through radiation and conductivity to raise its temperature to partially or fully vaporize it.

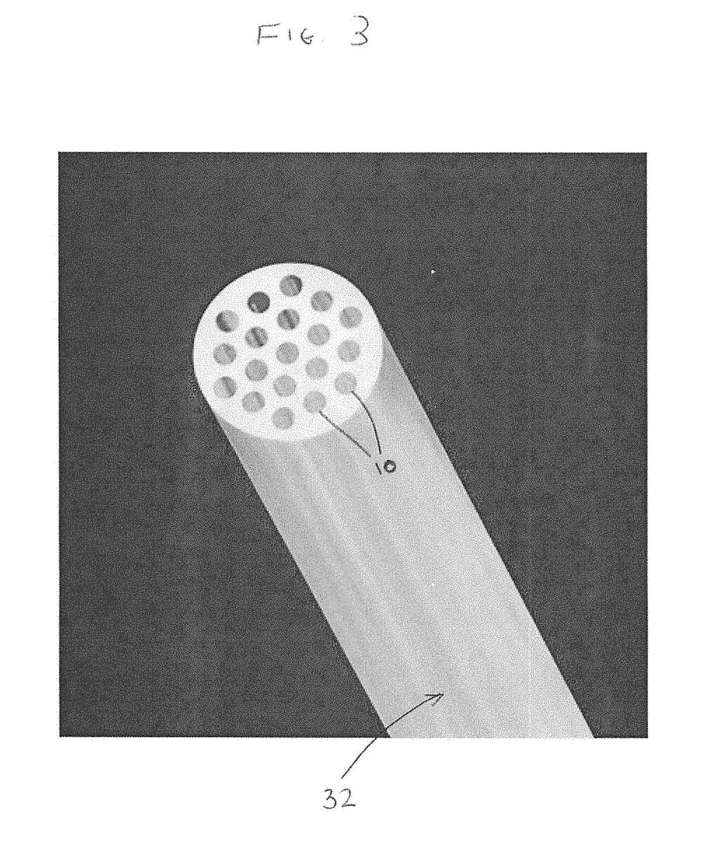

Referring now to FIG. 3, a plurality of tubular elements 10 are installed in parallel in a clamber 32 that contains the microwave radiation. The plurality of tubular elements 10 provide for the flow of large amount of fluid therethrough.

Temperature probes are installed on the inlet and outlet of elements 10 to monitor the temperature rise of stream 24 from inlet 26 to outlet 28. The heat transfer to the fluid of stream 24 is achieved by the microwaves interacting with the carbon nanotubes through both radiative and conductive forces. The fluid temperature is controlled by managing the flow rate of the fluid for the required outlet temperature, power supplied to the magnetron to generate microwaves, and the frequency and duration of the microwave pulses.

Preferably, the apparatus does not utilize fossil fuel to generate electricity for pumps or other energy consuming equipment or to generate the microwaves. It is preferred that solar panels are provided in connection with the apparatus to provide the required power. The solar panels are configured so that they can provide the required power.

The method and apparatus may be used for raising the temperature of a fluid stream in a wide range of pressures ranging from vacuum to high pressurized application. The applications include distillation operations in the refining and petrochemical industry, the production of alcohol products, or the treatment of water such as seawater, brines, brackish, wastewater, contaminated fresh water supply sources or water produced in conjunction with oil and gas operations to change it to clean water. The method or apparatus may be also used for basic tasks such as the heating of a cold fluid to a required use or reaction temperature such as cold hydraulic fracturing liquids, input feeds to refining distillation columns, or home heating of cold water for residential use.

The following examples further illustrate the invention but are not to be construed as limitations on the scope of the invention contemplated herein. A series of experiments were conducted to demonstrate the use of carbon nanotubes to heat a stream in accordance with the present invention.

A 1000 Watt magnetron was used in a light weight steel chamber with a perforated view screen to observe the interaction of the carbon nanotubes and the microwaves. No specific temperature measurements were made. Each experiment was run several times to confirm the findings. The experiment used Industrial Grade Multi-Wall Carbon Nanotubes purchased from CheapTubes.com which had the following properties:
Outer Diameter: 20-40 nanometers
Length: 10-30 micrometers
Purity: >90% by weight
Ash: <1.5% by weight

### EXAMPLE 1

A base case was run without carbon nanotubes by heating 200 mL of fresh water with microwave energy in a standard laboratory 500 mL glass beaker. Approximately 92 seconds was required to achieve a rapid boiling state.

### EXAMPLE 2

One gram of carbon nanotubes was added directly to 200 mL of new fresh water in a standard laboratory 500 mL glass beaker. Because carbon nanotubes are heavier than water, they quickly fell to the bottom of the beaker and a spoon was used to stir them and distribute them throughout the water. Microwave radiation was applied like in Example 1 and approximately 87 seconds was required to achieve a rapid boiling state.

### EXAMPLE 3

Five grams of carbon nanotubes was added directly to 200 mL of new fresh water in a standard laboratory 500 mL glass beaker. Microwave radiation was applied like in Example 1 and approximately 78 seconds was required to achieve a rapid boiling state.

### EXAMPLE 4

Ten grams of carbon nanotubes was added directly to 200 mL of new fresh water in a standard laboratory 500 mL glass beaker. Microwave radiation was applied like in Example 1 and approximately 77 seconds was required to achieve a rapid boiling state. It was not possible to distribute more carbon nanotubes into solution as the viscosity of the mixture was too thick to heat without splattering.

### EXAMPLE 5

One gram of carbon nanotubes without any water was heated via microwave radiation. Within 4 seconds, extreme heating was achieved in the beaker with the carbon nanotubes turning bright reddish-orange and the beaker too physically hot to handle without gloves. It is conjectured that the water molecules were preferentially absorbing the microwave radiation over the carbon nanotubes. Hence no significant advantage was seen in the other examples with a carbon nanotube/water mixture. Hence it is preferred to separate the mixture as disclosed in the present invention. The advantages of such separation are:
No requirements to pre-mix the carbon nanotubes into a fluid
Removes batch heating of fluids
Allows for a continuous operation heating of fluid passing through the inside chamber
No need to separate the carbon nanotubes once heating has been achieved

While the invention is described with respect to specific embodiments, modifications thereof can be made by one skilled in the art without departing from the spirit of the invention. The details of said embodiments are not to be construed as limitations except to the extent indicated in the following claims.

What is claimed is:

1. An apparatus, comprising:
a first body having a flow passage therethrough;
carbon nanotubes adjacent the first body; and
a source of microwave waves for providing microwave energy to the carbon nanotubes.

2. An apparatus according to claim 1 further including a second body having a chamber that contains the carbon nanotubes.

3. An apparatus according to claim 1 wherein the second body is a tubular member disposed over the first body.

4. An apparatus according to claim 1 wherein the first body is a tubular member.

5. A method of heating a material, comprising:
providing microwave energy to carbon nanotubes to generate heat; and
transferring the heat generated in the carbon nanotubes to the material.

6. The method according to claim 5 wherein the material is a liquid.

7. The method according to claim 5 wherein the material is a gas.

8. The method according to claim 5 wherein the material is wastewater.

9. The method according to claim 5 wherein the material is contaminated water.

10. The method according to claim 9 wherein the material is contaminated water produced in conjunction with oil and gas operations.

11. The method according to claim 5 wherein the material is a stream in a refinery.

12. The method according to claim 5 wherein the material is a stream in a petrochemical plant.

13. The method according to claim 5 wherein the material is a stream in a production of alcohol products operation.

14. The method according to claim 5 wherein the material is a hydraulic fracturing liquid.

15. The method according to claim 5 wherein the material is water.

16. The method according to claim 5 wherein the material is a fluid.
